(19) United States
(12) Patent Application Publication
(10) Pub. No.: US 2017/0061999 A1
(43) Pub. Date: Mar. 2, 2017

(54) MAGNETIC RECORDING MEDIUM AND MAGNETIC RECORDING AND REPRODUCING DEVICE

(71) Applicant: KABUSHIKI KAISHA TOSHIBA, Tokyo (JP)

(72) Inventors: Hirofumi SUTO, Tokyo (JP); Kiwamu Kudo, Kamakura (JP); Tazumi Nagasawa, Yokohama (JP); Taro Kanao, Tokyo (JP); Rie Sato, Yokohama (JP); Koichi Mizushima, Kamakura (JP)

(73) Assignee: Kabushiki Kaisha Toshiba

(21) Appl. No.: 15/247,182

(22) Filed: Aug. 25, 2016

(30) Foreign Application Priority Data
Aug. 27, 2015 (JP) 2015-168317

(51) Int. Cl. G11B 5/73

(52) U.S. Cl. CPC G11B 5/731

(57) ABSTRACT

According to one embodiment, a magnetic recording medium includes a first magnetic layer and a second magnetic layer. An easy magnetization axis of the first magnetic layer is aligned with a first direction. The first direction is from the first magnetic layer toward the second magnetic layer. The second magnetic layer has magnetic anisotropy in a plane perpendicular to the first direction. A second magnetization of the second magnetic layer is reverse orientation of a first magnetization of the first magnetic layer.

### CROSS-REFERENCE TO RELATED APPLICATIONS

This application is based upon and claims the benefit of priority from Japanese Patent Application No. 2015-168317, filed on Aug. 27, 2015; the entire contents of which are incorporated herein by reference.

### FIELD

Embodiments described herein relate generally to a magnetic recording medium and a magnetic recording and reproducing device.

### BACKGROUND

It is desirable to increase the recording density of a magnetic recording medium and a magnetic recording and reproducing device.

### BRIEF DESCRIPTION OF THE DRAWINGS

FIG. 1A and FIG. 1B are schematic cross-sectional views illustrating a magnetic recording medium according to a first embodiment;

FIG. 2 is a schematic view illustrating a characteristic of the magnetic recording medium according to the first embodiment;

FIG. 3 is a schematic view illustrating the magnetic recording medium according to the first embodiment;

FIG. 4 is a schematic plan view illustrating the magnetic recording medium according to the first embodiment;

FIG. 5 is a schematic view illustrating a state of use of the magnetic recording medium according to the first embodiment;

FIG. 6A and FIG. 6B are schematic views illustrating a characteristic of the magnetic recording medium;

FIG. 7A to FIG. 7D are schematic views illustrating characteristics of the magnetic recording medium;

FIG. 8 is a schematic view illustrating a state of use of the magnetic recording medium according to the first embodiment;

FIG. 9 is a schematic view illustrating a state of use of the magnetic recording medium according to the first embodiment;

FIG. 10 is a schematic cross-sectional view illustrating a magnetic recording medium according to a second embodiment;

FIG. 11A and FIG. 11B are schematic views illustrating an operation of the magnetic recording medium according to the second embodiment;

FIG. 12 is a schematic view illustrating a state of use of the magnetic recording medium according to the embodiment;

FIG. 13 is a schematic perspective view illustrating the magnetic recording and reproducing device according to the third embodiment; and

FIG. 14A and FIG. 14B are schematic perspective views illustrating portions of the magnetic recording and reproducing device according to the third embodiment.

### DETAILED DESCRIPTION

According to one embodiment, a magnetic recording medium includes a first magnetic layer and a second magnetic layer. An easy magnetization axis of the first magnetic layer is aligned with a first direction. The first direction is from the first magnetic layer toward the second magnetic layer. The second magnetic layer has magnetic anisotropy in a plane perpendicular to the first direction. A second magnetization of the second magnetic layer is reverse orientation of a first magnetization of the first magnetic layer.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

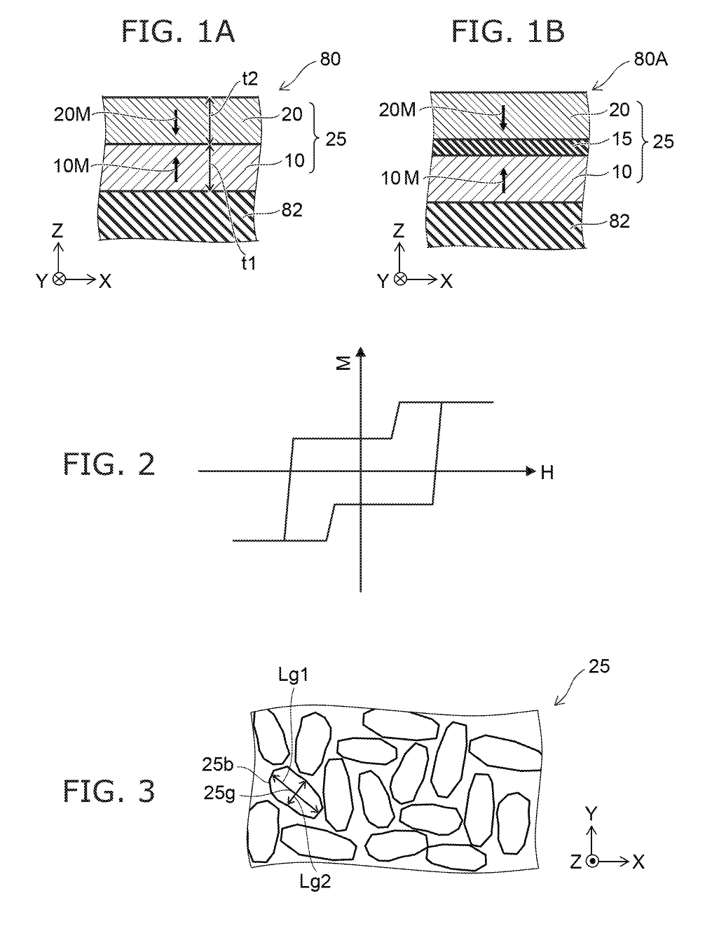

FIG. 1A and FIG. 1B are schematic cross-sectional views illustrating a magnetic recording medium according to a first embodiment.

As shown in FIG. 1A, the magnetic recording medium 80 according to the embodiment includes a first magnetic layer 10 and a second magnetic layer 20.

A direction from the first magnetic layer 10 toward the second magnetic layer 20 is taken as a first direction. The first direction is, for example, the stacking direction of the first magnetic layer 10 and the second magnetic layer 20. The first direction is taken as a Z-axis direction. One direction perpendicular to the Z-axis direction is taken as an X-axis direction. A direction perpendicular to the Z-axis direction and the X-axis direction is taken as a Y-axis direction. The first magnetic layer 10 and the second magnetic layer 20 spread along the X-Y plane.

In the example, the magnetic recording medium 80 further includes a substrate 82. The substrate 82 overlaps the first magnetic layer 10 and the second magnetic layer 20 in the first direction.

In the example, the first magnetic layer 10 is disposed between the substrate 82 and the second magnetic layer 20. In the embodiment, the second magnetic layer 20 may be disposed between the substrate 82 and the first magnetic layer 10.

The easy magnetization axis of the first magnetic layer 10 is aligned with the first direction. A first magnetization 10M (the direction of the first magnetization 10M) of the first magnetic layer 10 is aligned with the first direction. The angle between the first magnetization 10M and the first direction is smaller than the angle between the first magnetization 10M and the X-Y plane. The first magnetic layer 10 is, for example, a perpendicular magnetization film.

The second magnetic layer 20 has magnetic anisotropy in a plane (in the X-Y plane) perpendicular to the first direction. A second magnetization 20M of the second magnetic layer 20 is the reverse orientation of the first magnetization 10M of the first magnetic layer 10.

A recorded bit 25 of the magnetic recording medium 80 includes the first magnetic layer 10 and the second magnetic layer 20. The first magnetic layer 10 is, for example, a perpendicular magnetization film having the easy magnetization axis in the perpendicular direction. The first magnetization 10M of the first magnetic layer 10 has two stable directions. The two stable directions are, for example, “upward” and “downward.” For example, the information of one bit is recorded using these stable directions.

The second magnetic layer 20 has anisotropy in one direction in the plane. An antiferromagnetic interaction acts between the first magnetization 10M of the first magnetic layer 10 and the second magnetization 20M of the second magnetic layer 20.

The second magnetic layer 20 as a single body is a perpendicular magnetization film or an in-plane magnetization film. When the second magnetic layer 20 is stacked with the first magnetic layer 10, in the residual state, the second magnetization 20M is substantially perpendicular and antiparallel to the first magnetization 10M. This is based on the antiferromagnetic interaction.

For example, the magnetic anisotropy of the first magnetic layer 10 is larger than the effective magnetic field due to the antiferromagnetic interaction. Therefore, a reversal of the first magnetization 10M due to the antiferromagnetic interaction does not occur.

The first magnetic layer 10 includes, for example, a material having a large perpendicular magnetic anisotropy energy. Thereby, for example, high stability is obtained when recording information. The first magnetic layer 10 includes, for example, at least one of a CoCr-based alloy, an FePt-based alloy, a CoPt-based alloy, a multilayer film of Co/Pt, a multilayer film of Co/Pd, or a RE-TM alloy (a rare earth-iron group alloy).

For example, (Kᵤ·V)/(k_{B}·T) is an indicator of the stability of recording. “Kᵤ” is the magnetic anisotropy energy. “V” is the activation volume. “k_{B}” is the Boltzmann constant. “T” is the absolute temperature. In the first magnetic layer 10, it is desirable for (Kᵤ·V)/(k_{B}·T) to be, for example, greater than 60.

The second magnetic layer 20 includes, for example, a perpendicular magnetization film having a small perpendicular magnetic anisotropy energy. Thereby, for example, in the residual state, a spontaneous antiferromagnetic arrangement is obtained. The second magnetic layer 20 includes, for example, at least one of a CoCr-based alloy, a multilayer film of Co/Pt, or a multilayer film of Co/Pd.

The second magnetic layer 20 may be, for example, an in-plane magnetization film. The second magnetic layer 20 includes, for example, at least one of Co or Fe.

In the second magnetic layer 20, a substantially perpendicular antiferromagnetic arrangement is obtained spontaneously in the residual state due to the relationship between the thickness and antiferromagnetic coupling of the second magnetic layer 20.

The second magnetic layer 20 may include, for example, at least one of Al, Si, or B. Thereby, the saturation magnetization of the second magnetic layer 20 is adjusted. Thereby, the demagnetizing field may be controlled.

The second magnetic layer 20 has anisotropy in one direction in a plane (the X-Y plane). For example, the second magnetic layer 20 includes a material having magneto-crystalline anisotropy. For example, the second magnetic layer 20 may include a material having induced magnetic anisotropy. Thereby, the anisotropy in the plane (in the X-Y plane) is obtained in the second magnetic layer 20. For example, a magnetic field is applied in the film formation of the second magnetic layer 20. For example, heat treatment in a magnetic field or the like is performed after the film formation of the second magnetic layer 20. Thereby, the magneto-crystalline anisotropy or the induced magnetic anisotropy is caused effectively.

The second magnetic layer 20 may have shape magnetic anisotropy. For example, the shape anisotropy is obtained when patterning the configurations of the second magnetic layers 20. Thereby, the anisotropy in the plane (in the X-Y plane) is obtained in the second magnetic layer 20.

For example, in the residual state, the leakage magnetic field from the first magnetic layer 10 and the leakage magnetic field from the second magnetic layer 20 act to cancel each other. The leakage magnetic field that acts on the recorded bits 25 of the periphery weakens. Thereby, the change of the magnetization reversal conditions, which are dependent on the state of the recorded bits 25 of the periphery, becomes small. Thereby, a stable magnetization reversal is obtained.

For example, the leakage magnetic field is most reduced in the case where the magnetic volume of the first magnetic layer 10 and the magnetic volume of the second magnetic layer 20 are equal to each other. For example, the product (Ms1·t1) of a saturation magnetization Ms1 of the first magnetic layer 10 and a thickness t1 along the first direction (the Z-axis direction) of the first magnetic layer 10 is not less than 0.8 times and not more than 1.2 times the product (Ms2·t2) of a saturation magnetization Ms2 of the second magnetic layer 20 and a thickness t2 along the first direction of the second magnetic layer 20.

In the embodiment, the magnetic volume of the first magnetic layer 10 and the magnetic volume of the second magnetic layer 20 may be different from each other. The size relationship between the magnetic volume of the first magnetic layer 10 and the magnetic volume of the second magnetic layer 20 is arbitrary. In the embodiment, it is sufficient for the leakage magnetic field to be reduced to so that the recording operation is performed with sufficient stability.

Thus, for example, the first magnetic layer 10 has an easy magnetization axis in a direction perpendicular to the layer surface of the first magnetic layer 10 (the X-Y plane). The second magnetic layer 20 has magnetic anisotropy in one direction inside the X-Y plane. An interaction affects the first magnetization 10M of the first magnetic layer 10 and the second magnetization 20M of the second magnetic layer 20 so that the magnetizations of the first magnetization 10M and the second magnetization 20M become mutually opposite. For example, the coercivity of the first magnetic layer 10 is stronger than the effective magnetic field of the interaction. The second magnetization 20M of the second magnetic layer 20 becomes antiparallel to the first magnetization 10M of the first magnetic layer 10 in the residual state due to the interaction. The second magnetization 20M becomes substantially perpendicular to the X-Y plane.

As shown in FIG. 1B, another magnetic recording medium 80A according to the embodiment further includes a nonmagnetic layer 15 in addition to the first magnetic layer 10 and the second magnetic layer 20. Otherwise, the magnetic recording medium 80A is the same as the magnetic recording medium 80, and a description is therefore omitted.

The nonmagnetic layer 15 is provided between the first magnetic layer 10 and the second magnetic layer 20. The nonmagnetic layer 15 includes, for example, Ru. For example, the nonmagnetic layer 15 causes antiferromagnetic coupling between the first magnetization 10M and the second magnetization 20M.

The magnetic recording medium 80 of the embodiment will now be described. The description recited below is applicable also to the magnetic recording medium 80A.

FIG. 2 is a schematic view illustrating a characteristic of the magnetic recording medium according to the first embodiment.

FIG. 2 illustrates the characteristic of the magnetic recording medium 80. In FIG. 2, the horizontal axis is a magnetic field H. The vertical axis is a magnetization M.

As the magnetic field H increases in the magnetization curve of FIG. 2, the magnetization M changes in two stages; and the magnetization M transitions through three states. As the magnetic field H decreases, the magnetization M changes in two stages; and the magnetization M transitions through three states. The magnetization M has a total of four states.

As described above, the second magnetic layer 20 has anisotropy in the X-Y plane (in a plane perpendicular to the first direction). For example, the second magnetic layer 20 has at least one of magneto-crystalline anisotropy, induced magnetic anisotropy, or shape magnetic anisotropy. An example of the configuration of the second magnetic layer 20 will now be described.

FIG. 3 is a schematic view illustrating the magnetic recording medium according to the first embodiment.

FIG. 3 illustrates the recorded bit 25. As shown in FIG. 3, the recorded bit 25 includes multiple crystal grains 25g. The crystal grains 25g are surrounded with grain boundaries 25b.

In the example, the crystal grains 25g are anisotropic. A first length Lg1 along one direction of the crystal grain 25g is longer than a second length Lg2 along one other direction of the crystal grain 25g. The one direction is, for example, the major axis. The one other direction is, for example, the minor axis. The minor axis intersects the major axis. The major axis has a component along the X-Y plane.

Thus, one of the multiple crystal grains 25g has the first length Lg1 and the second length Lg2. The first length Lg1 is the length along a second direction perpendicular to the first direction (the Z-axis direction). The second length Lg2 is the length along a third direction perpendicular to the first direction and perpendicular to the second direction. In the embodiment, the first length Lg1 is different from the second length Lg2 in one of the multiple crystal grains 25g. The average of the first lengths Lg1 may be different from the average of the second lengths Lg2 for the multiple crystal grains 25g.

Thereby, shape magnetic anisotropy occurs in the crystal grains 25g. Thereby, magnetic anisotropy in the X-Y plane occurs in the second magnetic layer 20.

The multiple crystal grains 25g of the recorded bit 25 correspond to the multiple crystal grains provided in the second magnetic layer 20. In other words, the second magnetic layer 20 includes the multiple crystal grains (the crystal grains 25g). Each of the multiple crystal grains (the crystal grains 25g) has the first length Lg1 along the second direction perpendicular to the first direction, and the second length Lg2 along the third direction perpendicular to the first direction and perpendicular to the second direction. The first length Lg1 is different from the second length Lg2 for one of the multiple crystal grains (the crystal grains 25g) of the second magnetic layer 20. The average of the first lengths Lg1 may be different from the average of the second lengths Lg2 for the multiple crystal grains (the crystal grains 25g) of the second magnetic layer 20.

In the example, the directions of the major axes for the multiple crystal grains 25g are random. In the embodiment, the directions of the major axes for the multiple crystal grains 25g may be along one direction.

Thus, the recorded bit 25 may have a granular structure. For example, the recorded bit 25 is obtained by using a segregant to make, into a granular medium, the material that is used to form the recorded bits 25.

The segregant includes, for example, an oxide of nitride, C (carbon), etc. The oxide includes, for example, at least one selected from the group consisting of TiOₓ, SiOₓ, and MgOₓ. The nitride includes, for example, SiNₓ. The segregant may include, for example, silicon oxynitride.

At least one of a material having magneto-crystalline anisotropy or a material having induced magnetic anisotropy is used as the second magnetic layer 20. Thereby, magnetic anisotropy in the X-Y plane occurs in the second magnetic layer 20.

The shape magnetic anisotropy that acts on the crystal grains 25g may be utilized when making into the granular medium. Thereby, magnetic anisotropy in the X-Y plane occurs in the second magnetic layer 20.

Further, the use of the at least one of the material having magneto-crystalline anisotropy or the material having induced magnetic anisotropy may be implemented simultaneously with the utilization of the shape magnetic anisotropy acting on the crystal grains 25g.

When making the recorded bit 25 granular medium to utilize the shape magnetic anisotropy acting on the crystal grains 25g, the first magnetic layer 10 also is caused to have substantially the same configuration as the second magnetic layer 20. Therefore, in such a case, the shape magnetic anisotropy acts on the first magnetic layer 10 as well.

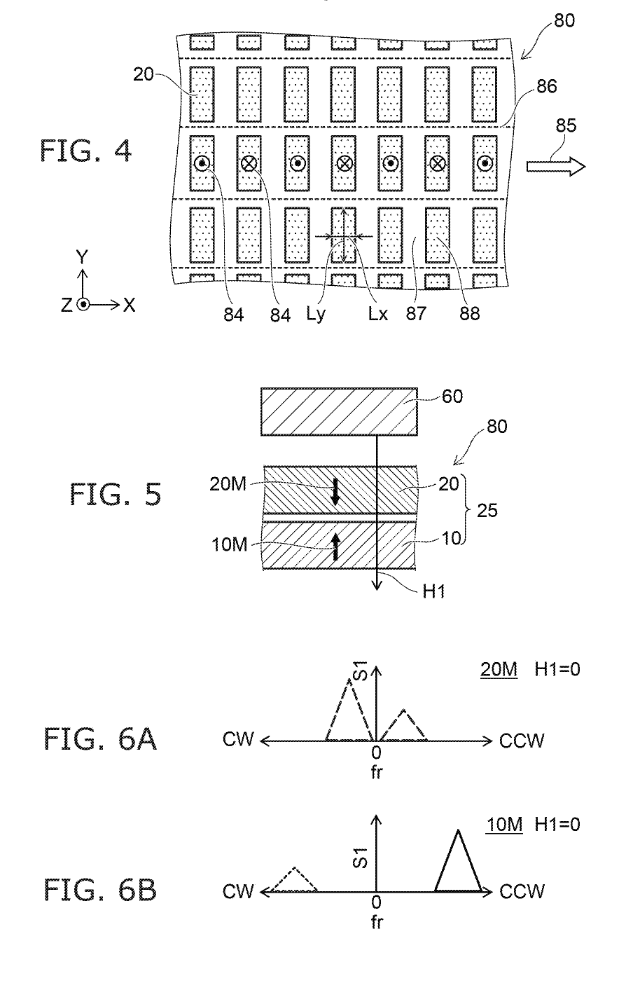

FIG. 4 is a schematic plan view illustrating the magnetic recording medium according to the first embodiment.

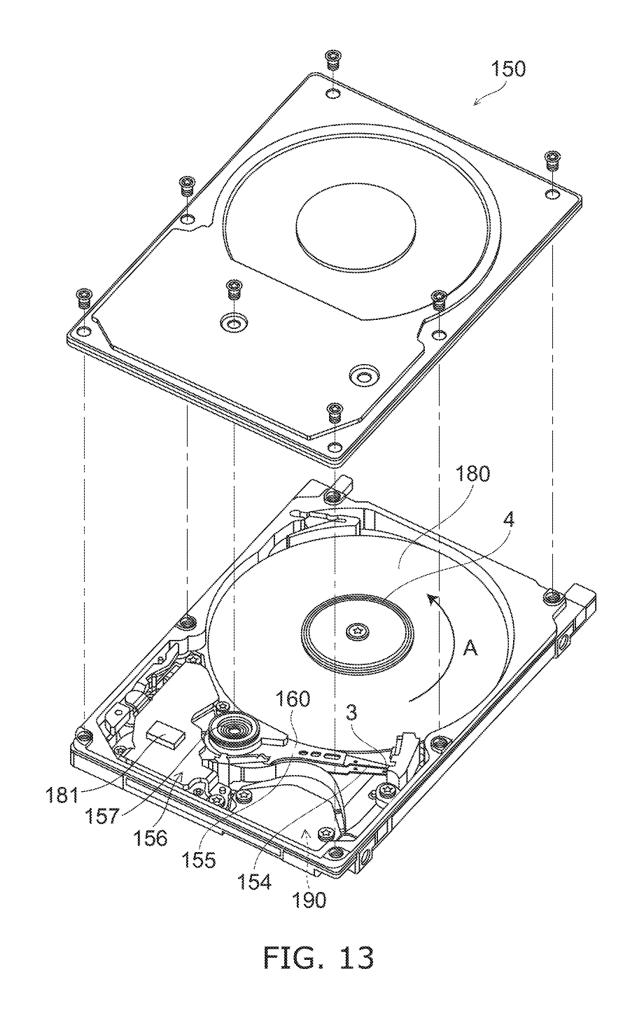

As shown in FIG. 4, a recording track 86 is provided in the magnetic recording medium 80. The recording track 86 extends along a medium movement direction 85. For example, the magnetic recording medium 80 has a circular disk configuration (referring to FIG. 13 described below). The recording track 86 substantially extends along the circumferential direction of the circle.

The magnetic recording medium 80 includes multiple discrete bits 88. A nonmagnetic body 87 is provided around each of the multiple discrete bits 88. The multiple discrete bits 88 are separated by the nonmagnetic body 87.

In other words, the magnetic recording medium 80 includes the multiple second magnetic layers 20. The multiple second magnetic layers 20 are arranged in the X-Y plane. For example, the nonmagnetic body 87 is provided around the multiple magnetic layers 20. A length Lx (a first axis length) in the X-axis direction (one direction (the second direction) perpendicular to the first direction) of one of the multiple second magnetic layers 20 is different from a length Ly (a second axis length) in the Y-axis direction (a direction (the third direction) perpendicular to the first direction and perpendicular to the second direction) of the one of the multiple second magnetic layers 20. In the example, the length Lx is shorter than the length Ly.

For example, the length Ly is not less than 1.5 times and not more than 5 times the length Lx.

In the example, by setting the length Lx to be different from the length Ly, shape magnetic anisotropy is caused to occur in the second magnetic layer 20. Thereby, magnetic anisotropy in the X-Y plane occurs in the second magnetic layer 20.

The substrate 82 is provided in the embodiment as described above (e.g., referring to FIG. 1A). The first magnetic layer 10 and the second magnetic layer 20 are provided on the substrate 82. The configuration in the X-Y plane (in a plane perpendicular to the first direction) of the substrate is, for example, a circle. In such a case, the second direction recited above (the direction of the length Lx) is aligned with the circumferential direction of the circle. The third direction recited above (the direction of the length Ly) is aligned with a radial direction passing through the center of the circle. The first axis length (the length Lx) is shorter than the second axis length (the length Ly).

Such a configuration is obtained by patterning, into the prescribed configurations, the film used to form the second magnetic layers 20. For example, such a configuration is obtained by patterning, into a bit-patterned medium, a stacked film including the first magnetic layer 10 and the second magnetic layer 20.

Thus, the shape magnetic anisotropy that acts on the magnetic bits (the recorded bits 25) is utilized by being patterned into the bit-patterned medium. Thereby, magnetic anisotropy in the X-Y plane occurs in the second magnetic layer 20. In the example, the second magnetic layer 20 may include at least one of a material having magneto-crystalline anisotropy or a material having induced magnetic anisotropy.

For example, when patterning into the bit-patterned medium to utilize the shape magnetic anisotropy acting on the magnetic bits (the recorded bits 25), the first magnetic layer 10 and the second magnetic layer 20 may be patterned to be substantially the same. At this time, the shape magnetic anisotropy acts on the first magnetic layer 10 as well.

In the embodiment, the first magnetic layer 10 may have the same planar configuration as the second magnetic layer 20 or may have a different planar configuration.

As described above, for example, the second magnetic layer 20 has at least one of magneto-crystalline anisotropy, induced magnetic anisotropy, or shape magnetic anisotropy. Thereby, the anisotropy in the X-Y plane is provided in the second magnetic layer 20.

According to the magnetic recording medium according to the embodiment as described below, the path of the magnetization motion of the second magnetic layer 20 has an elliptical configuration. Thereby, the magnetization motion of the first magnetic layer 10 is coupled to the magnetization motion of the second magnetic layer 20. Thereby, the strength of the assist effect changes; and the range of the microwave magnetic field frequencies at which the assist effect is obtained changes. According to the embodiment, stable assisted recording can be implemented. The assist effect is enhanced. A magnetic recording medium in which a higher recording density is possible can be provided.

An example of characteristics of the magnetic recording medium will now be described.

FIG. 5 is a schematic view illustrating a state of use of the magnetic recording medium according to the first embodiment.

As shown in FIG. 5, the recorded bit 25 of the magnetic recording medium 80 is proximal to a recording unit 60 of a magnetic head. A head field H1 from the recording unit 60 is applied to the recorded bit 25. The head field H1 causes magnetization reversal in the first magnetic layer 10. Thereby, the information is recorded. In the state illustrated in FIG. 5 (the state before the recording), the first magnetization 10M is upward; and the second magnetization 20M is downward. The magnetization oscillation of the recorded bit 25 will be described using this state as an example.

FIG. 6A and FIG. 6B are schematic views illustrating a characteristic of the magnetic recording medium.

These figures correspond to the state in which there is no head field H1 (the head field H1=0). FIG. 6A shows the response spectrum of the second magnetization 20M of the second magnetic layer 20 for a circularly polarized high frequency magnetic field. FIG. 6B shows the response spectrum of the first magnetization 10M of the first magnetic layer 10 for the circularly polarized high frequency magnetic field. In these figures, the horizontal axis is a frequency fr. The frequency fr is 0 at the center of the horizontal axis. The right side of the horizontal axis corresponds to the counterclockwise CCW circularly polarized frequency. The left side of the horizontal axis corresponds to the clockwise CW circularly polarized frequency. The vertical axis is an excitation strength S1 of the magnetization oscillation.

For example, the first magnetization 10M is upward. As shown in FIG. 6B, basically, the first magnetization 10M has a response for the counterclockwise CCW circularly polarized high frequency magnetic field at the ferromagnetic resonance (FMR) frequency vicinity.

On the other hand, the second magnetization 20M is downward. As shown in FIG. 6A, basically, the second magnetization 20M has a response for the clockwise CW circularly polarized high frequency magnetic field at the FMR frequency vicinity. Because of the in-plane magnetic anisotropy of the second magnetic layer 20, the path of the magnetization motion is shifted from a perfect circle and has an elliptical configuration. The path that is shifted from the perfect circle is the sum of the path of the clockwise CW perfect circle and the path of the counterclockwise CCW perfect circle. Thereby, as shown in FIG. 6A, there is a response also for the counterclockwise CCW circularly polarized high frequency magnetic field at the FMR frequency vicinity.

In the case where the shape magnetic anisotropy acts on the first magnetic layer 10, the path of the magnetization motion of the first magnetization 10M is shifted from a perfect circle and has an elliptical configuration. Thereby, as illustrated by the broken line of FIG. 6B, the first magnetization 10M has a response also for the clockwise CW circularly polarized high frequency magnetic field.

The perpendicular magnetic anisotropy of the first magnetic layer 10 storing the information is stronger than the antiferromagnetic coupling acting between the first magnetic layer 10 and the second magnetic layer 20. On the other hand, the second magnetization 20M spontaneously has an antiferromagnetic arrangement in the residual state due to the antiferromagnetic coupling acting between the first magnetic layer 10 and the second magnetic layer 20.

Thereby, the FMR frequency of the first magnetic layer 10 is higher than the FMR frequency of the second magnetic layer 20 when there is no head field H1. In the case where the magnetic anisotropy that is caused by the configuration acts on the first magnetic layer 10, the path of the magnetization motion is shifted from the perfect circle into an elliptical configuration. Therefore, as illustrated by the broken line in FIG. 6B, there is a response also for the clockwise CW circularly polarized high frequency magnetic field.

In the case where the orientations of the magnetizations (the first magnetization 10M and the second magnetization 20M) of the recorded bit 25 are the reverse of those of the state shown in FIG. 5 (the case where the first magnetization 10M is downward and the second magnetization 20M is upward), the response spectra of the magnetizations for the circularly polarized high frequency magnetic field are the reverse of those of the description recited above for clockwise CW and counterclockwise CCW.

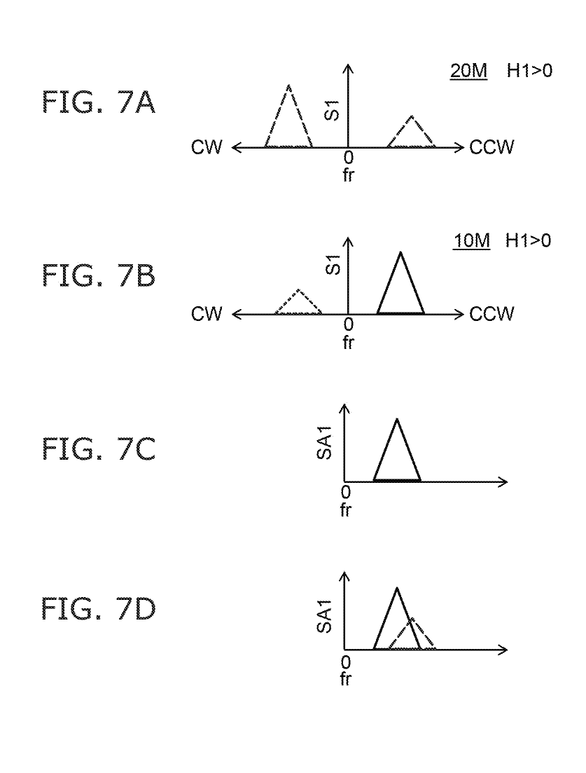

FIG. 7A to FIG. 7D are schematic views illustrating characteristics of the magnetic recording medium.

These figures correspond to the state in which the head field H1 is applied to the recorded bit 25 (the state in which of the head field H1>0). FIG. 7A shows the response spectrum of the second magnetization 20M for the circularly polarized high frequency magnetic field. FIG. 7B shows the response spectrum of the first magnetization 10M for the circularly polarized high frequency magnetic field. In these figures, the horizontal axis is the frequency fr. In these figures, the vertical axis is the excitation strength S1 of the magnetization oscillation.

FIG. 7C and FIG. 7D illustrate the high frequency magnetic field frequency dependence of the assist effect. FIG. 7C corresponds to the case where there is no coupling of the magnetization oscillation between the first magnetization 10M and the second magnetization 20M. FIG. 7D corresponds to the case where there is coupling of the magnetization oscillations. In FIG. 7C and FIG. 7D, the horizontal axis is the frequency fr. In these figures, the vertical axis is a strength SA1 of the assist effect.

The head field H1 causes magnetization reversal in the first magnetic layer 10. The head field H1 is antiparallel to the first magnetization 10M. In other words, the head field H1 is parallel to the second magnetization 20M.

The head field H1 causes the FMR frequency of the first magnetic layer 10 to be lower than the FMR frequency in the state illustrated in FIG. 6B. The FMR frequency of the second magnetic layer 20 is caused to be higher than the FMR frequency in the state illustrated in FIG. 6A.

In this state, the response spectra of the first magnetization 10M and the second magnetization 20M for the circularly polarized high frequency magnetic field overlap for the counterclockwise CCW component. Therefore, the motions of the two magnetizations are coupled by the antiferromagnetic coupling and the dipole interaction between the first magnetization 10M and the second magnetization 20M. By causing the coupling, the frequency of the high frequency magnetic field at which the assist effect of the magnetization reversal of the first magnetic layer 10 is obtained changes; and the strength of the assist effect at that frequency changes.

When there is no coupling of the magnetization oscillations, an assist effect is obtained for a high frequency magnetic field matching the response spectrum of the first magnetization 10M for the circularly polarized high frequency magnetic field illustrated in FIG. 7B. Therefore, at this time, the high frequency magnetic field frequency dependence of the assist effect becomes the state illustrated in FIG. 7C.

On the other hand, when there is coupling of the magnetization oscillations, an assist effect is obtained for both the response spectrum of the first magnetization 10M for the circularly polarized high frequency magnetic field illustrated in FIG. 7B and the response spectrum of the second magnetization 20M for the circularly polarized high frequency magnetic field illustrated in FIG. 7A. Therefore, the high frequency magnetic field frequency dependence of the assist effect becomes the state illustrated in FIG. 7D. In other words, the assist effect becomes stronger at the overlapping portion of the two spectra.

In the case where the magnetic anisotropy caused by the configuration acts on the first magnetic layer 10, the path of the magnetization motion is shifted from the perfect circle and has an elliptical configuration. Therefore, as illustrated by the broken line FIG. 7B, there is a response also for the clockwise CW circularly polarized high frequency magnetic field. At this time, the response spectra of the first magnetization 10M and the second magnetization 20M for the circularly polarized high frequency magnetic field also overlap for the clockwise CW component. Therefore, the coupling of the two magnetization motions becomes even stronger.

Thus, in the embodiment, when the recording magnetic field (the head field H1) is applied, at least a portion of the ferromagnetic resonance frequency band of the first magnetic layer 10 overlaps at least a portion of the ferromagnetic resonance frequency band of the second magnetic layer 20. The magnetization motion of the first magnetic layer 10 and the magnetization motion of the second magnetic layer 20 are coupled by at least one of an antiferromagnetic interaction or a dipole interaction.

In the case where the magnetization directions (the first magnetization 10M and the second magnetization 20M) of the recorded bit 25 are the opposite of those of the state shown in FIG. 5 (the case where the first magnetization 10M is downward, the second magnetization 20M is upward, and the head field H1 is upward), the response spectra of the magnetizations for the circularly polarized high frequency magnetic field are the reverse of those of the description recited above for clockwise CW and counterclockwise CCW.

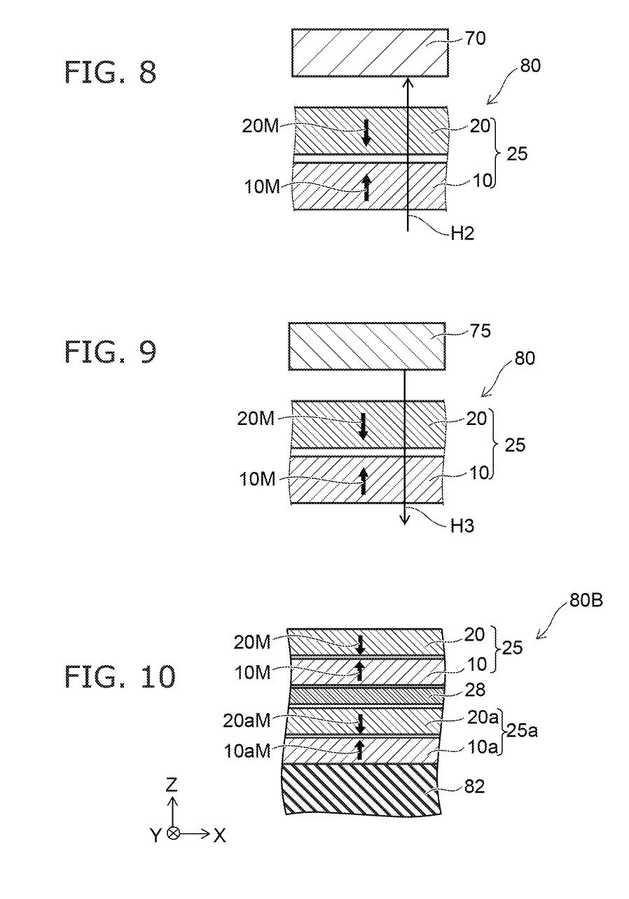

FIG. 8 is a schematic view illustrating a state of use of the magnetic recording medium according to the first embodiment.

As shown in FIG. 8, the recorded bit 25 of the magnetic recording medium 80 is proximal to a reproducing unit 70 of the magnetic head. The reproducing unit 70 is capable of sensing the magnetic field.

The leakage magnetic fields from the first magnetic layer 10 and the second magnetic layer 20 that are coupled antiferromagnetically act to cancel each other. At this time, between the first magnetic layer 10 and the second magnetic layer 20, there is a difference of magnetic volumes; and there is a difference of distances to the reproducing unit 70. Therefore, a leakage magnetic field H2 is generated. The leakage magnetic field H2 is applied to the reproducing unit 70.

In the example of FIG. 8, the magnetic volume of the first magnetic layer 10 is larger than the magnetic volume of the second magnetic layer 20. The direction of the leakage magnetic field H2 is parallel to the direction of the first magnetization 10M. Conversely, in the case where the magnetic volume of the second magnetic layer 20 is larger than the magnetic volume of the first magnetic layer 10, the direction of the leakage magnetic field H2 is parallel to the direction of the second magnetization. By using the reproducing unit 70 to sense the leakage magnetic field H2, the information that is recorded in the recorded bit 25 is reproduced.

FIG. 9 is a schematic view illustrating a state of use of the magnetic recording medium according to the first embodiment.

As shown in FIG. 9, the recorded bit 25 of the magnetic recording medium 80 is proximal to a reproducing unit 75 of the magnetic head. The reproducing unit 75 can sense magnetic resonance.

The magnetic field that is applied to the recorded bits of the periphery of the recorded bit 25 weakens as the leakage magnetic field generated by the recorded bit 25 decreases. The change of the assist effect that is dependent on the state of the recorded bits of the periphery becomes small. However, when the leakage magnetic field is reduced, the sensing is difficult using a method for sensing the leakage magnetic field. For example, this problem is solved by using the reproducing unit 75 that can sense the FMR frequency.

The reproducing unit 75 applies a reproduction magnetic field H3 to the recorded bit 25. The strength of the reproduction magnetic field H3 is a strength at which magnetization reversal does not occur in the first magnetic layer 10. Thereby, the FMR frequency of the first magnetization 10M changes according to the direction of the first magnetization 10M.

In the example shown in FIG. 9, the reproduction magnetic field H3 and the first magnetization 10M are antiparallel to each other. Therefore, compared to the residual state, the FMR frequency of the first magnetization 10M decreases. On the other hand, when the magnetization direction of the first magnetization 10M is the reverse orientation of the reproduction magnetic field H3, the FMR frequency of the first magnetization 10M increases. The change of the FMR frequency is sensed using the reproducing unit 75. Thereby, the information that is recorded in the recorded bit 25 can be reproduced.

Magnetization reversal does not occur when reproducing the information. Therefore, the magnetization direction of the second magnetization 20M that is antiparallel to the first magnetization 10M in the residual state may be sensed using the FMR frequency. In such a case as well, the reproduction magnetic field H3 is applied to the recorded bit 25. Thereby, the FMR frequency of the second magnetization 20M changes according to the magnetization direction of the second magnetization 20M. The information is reproduced by sensing the change of the frequency.

Generally, in a magnetic recording device, the recording and reproducing of the information are performed by utilizing the magnetization state. The magnetic recording device has the features of a large recording capacity, a high-speed reproduce/recording speed, nonvolatile recording, an inexpensive bit cost, etc. More performance improvement is desirable for the magnetic recording device.

The recording density increase of magnetic recording to date has been realized by downscaling the recorded bits. However, such methods have reached limits. To downscale the recorded bits, a medium material having a high magnetic anisotropy energy is used to satisfy the conditions of thermal stability expressed by (Kᵤ·V)/(k_{B}·T). Because such a medium material has high coercivity, the strength of the head field generated by the recording head is insufficient; the magnetization reversal cannot be caused to occur; and the recording of the information cannot be performed. For example, a trilemma occurs.

Microwave assisted magnetic recording (MAMR) has been proposed to solve this problem. In this method, a high frequency magnetic field from the recording head is applied, with the head field, to the recording medium. By exciting the magnetization oscillation of the recorded bit, magnetization reversal is performed using a head field that is not more than the coercivity. The reduction effect of the magnetic switching field is called the assist effect. By MAMR, it is possible to record the information in a medium material having high magnetic anisotropy. Thereby, the stability of recording improves; and a high recording density is obtained.

To obtain the assist effect in a recording method that uses a high frequency magnetic field, the frequency of the high frequency magnetic field applied to the recorded bit is adjusted by considering the FMR frequency of the magnetic body. The FMR frequency is expressed by (γ/2π)·Heff, where γ is the gyromagnetic ratio, and Heff is the effective magnetic field acting on the magnetic body.

For one recorded bit, the leakage magnetic field generated by the recorded bits of the periphery of the one recorded bit is applied to the one recorded bit. Therefore, the effective magnetic field changes according to the magnetization state of the recorded bits of the periphery. Therefore, the FMR frequency also changes; and a problem occurs in which a stable assist effect is not obtained.

To solve this problem, there is a method that uses an antiferromagnetic coupling (AFC) medium in which two layers of magnetic bodies are coupled antiferromagnetically. In this method, the leakage magnetic field from the recorded bit decreases. However, in the AFC medium, the magnetic layer that is added to cancel the leakage magnetic field does not contribute to the assist effect. This is because the coupling of magnetization motion between the two magnetic bodies does not occur and the rotation directions of the magnetization motions of the magnetic layers are reversed because the two magnetic layers are antiparallel in the AFC medium.

The magnetic recording medium according to the embodiment solves this problem. In the embodiment, the assist effect can be generated stably without being affected by the surrounding bits. In the embodiment, the strength of the assist effect and the microwave magnetic field frequency at which the assist effect is obtained can be controlled. Thereby, the microwave magnetic field frequency range at which the assist effect is obtained can be extended. For example, the assist effect can be generated at conditions corresponding to the application. The performance of the magnetic recording device can be improved.

In the embodiment, the second magnetic layer 20 has magnetic anisotropy in the plane. The magnetic anisotropy causes the path of the magnetization motion of the second magnetic layer 20 to distort from the perfect circle into an elliptical configuration. Thereby, the magnetization motion of the first magnetic layer 10 and the magnetization motion of the second magnetic layer 20 are coupled. Thereby, the strength of the assist effect changes; and the range of the microwave magnetic field frequencies at which the assist effect is obtained changes.

According to the embodiment, stable assisted recording can be implemented in a magnetic recording that utilizes an assist effect caused by a high frequency magnetic field. The assist effect can be enhanced. Thereby, a magnetic recording medium in which a higher recording density is possible can be provided.

### Second Embodiment

FIG. 10 is a schematic cross-sectional view illustrating a magnetic recording medium according to a second embodiment.

As shown in FIG. 10, a magnetic recording medium 80B according to the embodiment further includes a third magnetic layer 10a, a fourth magnetic layer 20a, and an intermediate layer 28 in addition to the first magnetic layer 10 and the second magnetic layer 20. The intermediate layer 28 is nonmagnetic.

The third magnetic layer 10a overlaps the first magnetic layer 10 and the second magnetic layer 20 in the first direction from the first magnetic layer 10 toward the second magnetic layer 20. The fourth magnetic layer 20a overlaps the first magnetic layer 10 and the second magnetic layer 20 in the first direction.

The intermediate layer 28 is disposed between the set of the third magnetic layer 10a and the fourth magnetic layer 20a and the set of the first magnetic layer 10 and the second magnetic layer 20.

For example, the configuration described in reference to the first magnetic layer 10 is applied to the third magnetic layer 10a. For example, the configuration described in reference to the second magnetic layer 20 is applied to the fourth magnetic layer 20a.

The easy magnetization axis of the third magnetic layer 10a is aligned with the first direction. A third magnetization 10aM of the third magnetic layer 10a is aligned with the first direction. The third magnetic layer 10a is, for example, a perpendicular magnetization film. The fourth magnetic layer 20a has magnetic anisotropy in a plane (in the X-Y plane) perpendicular to the first direction. A fourth magnetization 20aM of the fourth magnetic layer 20a is the reverse orientation of the third magnetization 10aM of the third magnetic layer 10a.

The set of the third magnetic layer 10a and the fourth magnetic layer 20a is used as another recorded bit 25a. Otherwise, the magnetic recording medium 80B is similar to the magnetic recording medium 80 or the magnetic recording medium 80A described above.

For example, the magnetic recording medium 80 or the magnetic recording medium 80A according to the first embodiment is multiply stacked in the magnetic recording medium 80B. The magnetic recording medium 80B is, for example, a perpendicular recording medium for three-dimensional magnetic recording.

The first magnetic layer 10 and the third magnetic layer 10a are, for example, perpendicular magnetization films. The second magnetic layer 20 is a stacked magnetic layer that is stacked with the first magnetic layer 10. The fourth magnetic layer 20a is a stacked magnetic layer that is stacked with the third magnetic layer 10a.

For example, the ferromagnetic resonance frequency of the third magnetic layer 10a is different from the ferromagnetic resonance frequency of the first magnetic layer 10.

The intermediate layer 28 includes at least one of a nonmagnetic metal material or a nonmagnetic insulating material. The intermediate layer 28 may include, for example, at least one selected from the group consisting of Ti, Cr, and Ta. The intermediate layer 28 may include, for example, MgOₓ. The intermediate layer 28 may include a stacked film in which at least one of a film of a nonmagnetic metal material or a film of a nonmagnetic insulating material is stacked.

For example, the intermediate layer 28 breaks the magnetic coupling due to the exchange interaction between the recorded bit 25 and the recorded bit 25a. The intermediate layer 28 controls the crystal orientation of these recorded bits (recording layers).

Two layers of multilayer recording media are shown in the example shown in FIG. 10. The number of alternating stacks of the recorded bit and the intermediate layer is arbitrary.

In the magnetic recording medium 80B (the perpendicular recording medium for three-dimensional magnetic recording), for example, the magnetizations (the first magnetization 10M, the third magnetization 10aM, etc.) of the multiple recording layers (recorded bits) have mutually-different FMR frequencies. The frequency of the high frequency wave at which the assist effect is obtained is different between the multiple recording layers. Selective magnetization reversal is possible for the selected recording layer (the recorded bit 25, the recorded bit 25a, etc.).

An example of the selective magnetization reversal of the multiple recording layers will now be described.

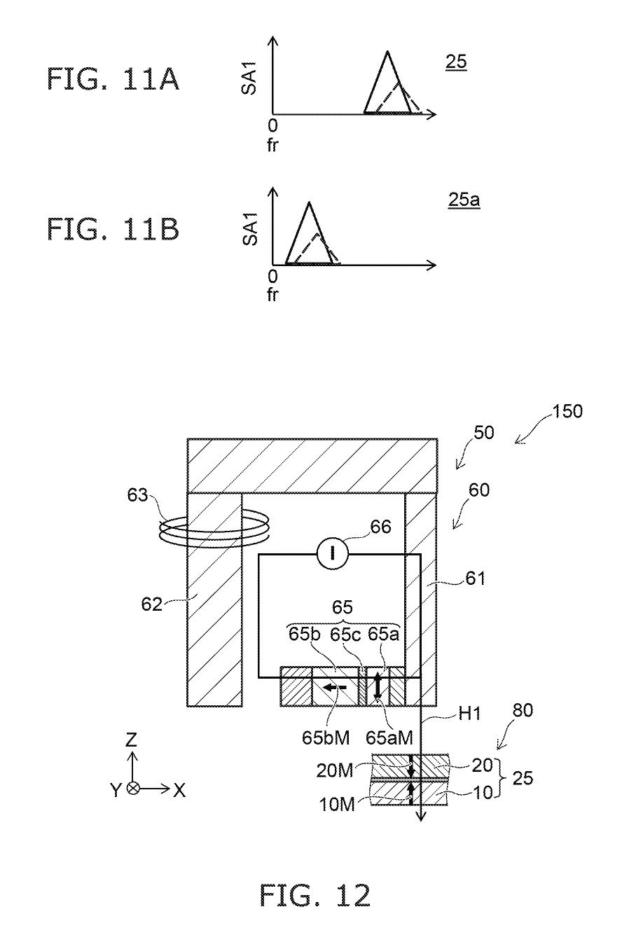

FIG. 11A and FIG. 11B are schematic views illustrating an operation of the magnetic recording medium according to the second embodiment.

FIG. 11A corresponds to the recorded bit 25a. FIG. 11B corresponds to the recorded bit 25.

FIG. 11A illustrates the high frequency magnetic field dependence of the assist effect of the recorded bit 25 (the recording layer) when the head field H1 is applied. Magnetization motion is coupled in the first magnetic layer 10 and the second magnetic layer 20 included in the recorded bit 25. Similarly to the description relating to FIG. 7D, the assist effect is obtained for both the response spectrum of the first magnetization 10M for the circularly polarized high frequency magnetic field and the response spectrum of the second magnetization 20M for the circularly polarized high frequency magnetic field.

FIG. 11B illustrates the high frequency magnetic field dependence of the assist effect of the recorded bit 25a (the recording layer) when the head field H1 is applied. The FMR frequency of the third magnetization 10aM of the third magnetic layer 10a and the FMR frequency of the fourth magnetization 20aM of the fourth magnetic layer 20a are respectively different from the FMR frequency of the first magnetization 10M of the first magnetic layer 10 and the FMR frequency of the second magnetization 20M of the second magnetic layer 20. Thereby, the high frequency magnetic field frequency at which the assist occurs in the recorded bit 25a can be shifted from that of the recorded bit 25.

High frequency magnetic fields having frequencies corresponding respectively to the multiple recorded bits are applied. Thereby, reversal is caused in the selected recorded bit (recording layer).

The high frequency magnetic field frequency bands that provide the assist effect do not overlap for the multiple recording layers in the three-dimensional magnetic recording. It is desirable for the assist effect of one recording layer to occur strongly in a narrow range of high frequency magnetic field frequencies.

For example, when the head field H1 is applied, it is favorable for the FMR frequency of the first magnetic layer 10 to be substantially the same as the FMR frequency of the second magnetic layer 20 in the recorded bit 25. It is favorable for the difference between the FMR frequency of the first magnetic layer 10 and the FMR frequency of the second magnetic layer 20 to be not more than 1/10 of the FMR frequency of the first magnetic layer 10.

For example, when the head field H1 is applied, it is favorable for the FMR frequency of the third magnetic layer 10a to be substantially the same as the FMR frequency of the fourth magnetic layer 20a in the recorded bit 25a. It is favorable for the difference between the FMR frequency of the third magnetic layer 10a and the FMR frequency of the fourth magnetic layer 20a to be not more than 1/10 of the FMR frequency of the third magnetic layer 10a.

By causing the FMR frequencies to substantially match, for example, a strong assist effect can be obtained in one recording layer in a narrow range of high frequency magnetic field frequencies. The high frequency magnetic field frequency bands that provide the assist effect can be set substantially not to overlap for the multiple recording layers.

In the reproduction of the information in the magnetic recording medium 80B, for example, similarly to the description relating to FIG. 8, the leakage magnetic field from each of the multiple recording layers may be sensed. At this time, in the reproducing unit 70, the sum of the leakage magnetic fields from the multiple recording layers is sensed. For example, the magnitudes of the leakage magnetic fields from the multiple recording layers are modified. Thereby, the magnetization states of the multiple recording layers are sensed from the sum of the leakage magnetic fields. Thereby, the information is reproduced.

Similarly to the description relating to FIG. 9, the FMR frequency of each of the multiple recording layers may be sensed. Thereby, the information is reproduced. The magnetizations of the multiple recording layers have mutually-different FMR frequencies. By applying the reproduction magnetic field H3 to the recorded bit (the recording layer), the FMR frequency of the magnetization of the perpendicular magnetic layer (e.g., the first magnetic layer 10, the third magnetic layer 10a, etc.) changes according to the direction of the magnetization. The information is reproduced by sensing the change of the FMR frequency. At this time, the strength of the reproduction magnetic field H3 is adjusted so that the changed FMR frequency does not overlap the FMR frequency of the other recorded bits. In the reproduction, the FMR frequencies of the magnetizations of the stacked magnetic layers (the second magnetic layer 20, the fourth magnetic layer 20a, etc.) of the multiple recording layers (recorded bits) may be sensed.

FIG. 12 is a schematic view illustrating a state of use of the magnetic recording medium according to the embodiment.

In the example shown in FIG. 12, the magnetic recording medium 80 is provided in a magnetic recording and reproducing device 150. The magnetic recording medium 80 is proximal to the recording unit 60 of a magnetic head 50.

The recording unit 60 includes a major electrode 61, a return path 62, a coil 63, and a spin torque oscillator 65.

A current that corresponds to the information is caused to flow in the coil 63. A magnetic field (the head field H1) is generated by the major electrode 61 due to the current. The major electrode 61 applies the head field H1 to the recorded bit 25 of the magnetic recording medium 80. The head field H1 is, for example, a recording magnetic field. At least a portion of the head field H1 passes through the return path 62.

The spin torque oscillator 65 is disposed between the major electrode 61 and the return path 62. The spin torque oscillator 65 generates a high frequency magnetic field.

The spin torque oscillator 65 includes, for example, a generation layer 65a, a spin injection layer 65b, and a nonmagnetic spin transmission layer 65c. The nonmagnetic spin transmission layer 65c is disposed between the generation layer 65a and the spin injection layer 65b.

A current is supplied to the spin torque oscillator 65 using a current source 66. A magnetization 65aM of the generation layer 65a oscillates. The high frequency magnetic field that is generated with the oscillation is applied to the recorded bit 25. At this time, the frequency of the high frequency magnetic field is adjusted to excite the coupling motion between the first magnetization 10M and the second magnetization 20M in the recorded bit 25. Magnetization reversal of the first magnetization 10M is caused to occur by exciting the coupling motion between the first magnetization 10M and the second magnetization 20M.

The spin injection layer 65b, and the nonmagnetic spin transmission layer 65c, the number of layers, the order of the stacking, the direction of a magnetization 65bM of the spin injection layer 65b, and the direction of the current are arbitrary for the generation layer 65a as long as the assist effect recited above causing the magnetization reversal to occur is provided.

In the example, the magnetization is reversed for the recorded bit 25 of a single-layer recording medium. The reversal of the magnetization of the recorded bit of any one layer of the multiple recording layers of a three-dimensional magnetic recording medium also can be implemented similarly.

### Third Embodiment

The embodiment relates to the magnetic recording and reproducing device 150.

As shown in FIG. 12, the magnetic recording and reproducing device 150 includes the magnetic head 50 and the magnetic recording medium (e.g., the magnetic recording medium 80 or the like) according to the first and second embodiments. The magnetic head 50 applies a magnetic field to the magnetic recording medium 80. The magnetic head 50 applies a high frequency magnetic field and a recording magnetic field (the head field H1) to the magnetic recording medium 80.

FIG. 13 is a schematic perspective view illustrating the magnetic recording and reproducing device according to the third embodiment.

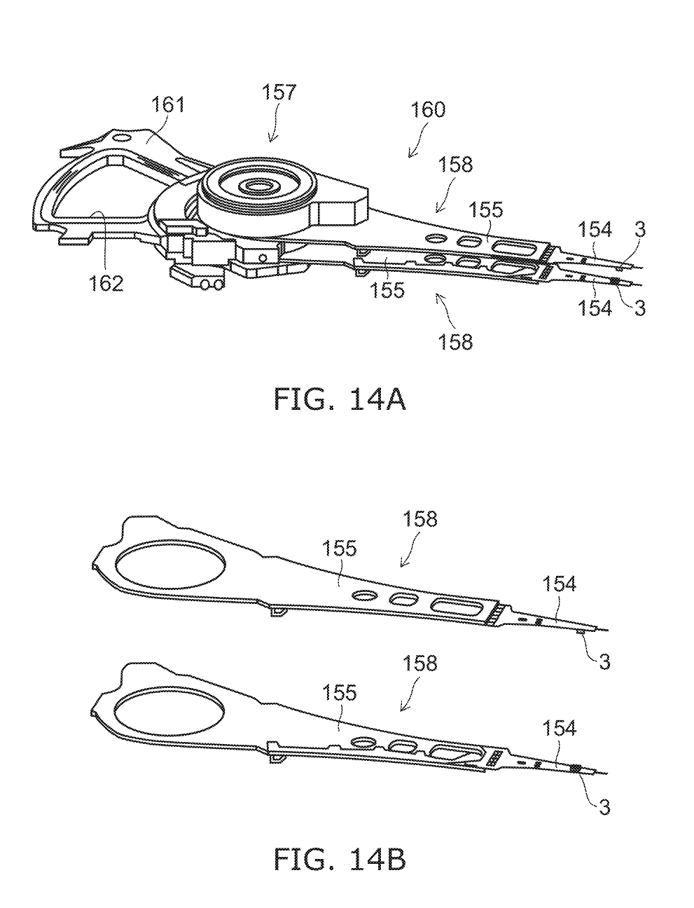

FIG. 14A and FIG. 14B are schematic perspective views illustrating portions of the magnetic recording and reproducing device according to the third embodiment.

As shown in FIG. 13, the magnetic recording and reproducing device 150 according to the embodiment is a device that uses a rotary actuator.

A recording medium disk 180 illustrated in FIG. 13 corresponds to at least one of the magnetic recording medium 80, 80A, or 80B according to the first and second embodiments.

The recording medium disk 180 is mounted to a spindle motor 4 and is rotated in the direction of arrow A by a motor that responses to a control signal from a drive device controller. The magnetic recording and reproducing device 150 according to the embodiment may include multiple recording medium disks 180.

The magnetic recording and reproducing device 150 may include a recording medium 181. For example, the magnetic recording and reproducing device 150 is a hybrid HDD (Hard Disk Drive). The recording medium 181 is, for example, a SSD (Solid State Drive). The recording medium 181 includes, for example, nonvolatile memory such as flash memory, etc.

A head slider 3 that performs the recording and reproducing of the information stored in the recording medium disk 180 includes the magnetic head 50. The magnetic head 50 includes the recording unit 60 and the reproducing unit 70 recited above.

The head slider 3 is mounted to the tip of a suspension 154 having a thin-film configuration.

When the recording medium disk 180 rotates, the medium-opposing surface (the ABS) of the head slider 3 is held at a prescribed fly height from the surface of the recording medium disk 180 by the balance between the downward pressure due to the suspension 154 and the pressure generated by the medium-opposing surface of the head slider 3. The head slider 3 may be “contact-sliding.” In such a case, the head slider 3 contacts the recording medium disk 180.

The suspension 154 is connected to one end of an actuator arm 155 that includes a bobbin unit holding a drive coil, etc. A voice coil motor 156 which is one type of linear motor is provided at one other end of the actuator arm 155. The voice coil motor 156 includes a drive coil that is wound onto the bobbin unit of the actuator arm 155, and a magnetic circuit that includes a permanent magnet and an opposing yoke disposed to oppose each other with the coil interposed. The suspension 154 has one end and one other end; the magnetic head is mounted to the one end of the suspension 154; and the actuator arm 155 is connected to the one other end of the suspension 154.

The actuator arm 155 is held by ball bearings provided at two locations on and under a bearing unit 157. The actuator arm 155 can be caused to rotate and slide by the voice coil motor 156. The magnetic head 50 is movable to any position of the recording medium disk 180.

FIG. 14A illustrates a portion of the magnetic recording and reproducing device and is an enlarged perspective view of a head stack assembly 160.

FIG. 14B is a perspective view illustrating a magnetic head assembly (a head gimbal assembly (HGA)) 158 which is a portion of the head stack assembly 160.

As shown in FIG. 14A, the head stack assembly 160 includes the bearing unit 157, the head gimbal assembly 158, and a support frame 161. The head gimbal assembly 158 extends from the bearing unit 157. The support frame 161 extends in the opposite direction of the HGA from the bearing unit 157. The support frame 161 supports a coil 162 of the voice coil motor.

As shown in FIG. 14B, the head gimbal assembly 158 includes the actuator arm 155 that extends from the bearing unit 157, and the suspension 154 that extends from the actuator arm 155. The head slider 3 is mounted to the tip of the suspension 154.

The suspension 154 includes, for example, lead wires (not shown) that are for recording and reproducing signals, for a heater that adjusts the fly height, for a spin torque oscillator, etc. The lead wires are electrically connected to electrodes of the magnetic head embedded in the head slider 3.

A signal processor 190 is provided to record and reproduce the signals to and from the magnetic recording medium by using the magnetic head. For example, the signal processor 190 is provided on the backside of the magnetic recording and reproducing device 150. For example, the input/output lines of the signal processor 190 are electrically coupled to the magnetic head by being connected to electrode pads of the head gimbal assembly 158.

The embodiments include the following features.

### (Feature 1)

A magnetic recording medium, comprising:

a first magnetic layer; and

a second magnetic layer,

an easy magnetization axis of the first magnetic layer being aligned with a first direction, the first direction being from the first magnetic layer toward the second magnetic layer,

the second magnetic layer having magnetic anisotropy in a plane perpendicular to the first direction,

a second magnetization of the second magnetic layer being reverse orientation of a first magnetization of the first magnetic layer.

### (Feature 2)

The medium according to feature 1, further comprising a nonmagnetic layer provided between the first magnetic layer and the second magnetic layer.

### (Feature 3)

The medium according to feature 1 or 2, wherein the magnetic anisotropy includes magneto-crystalline anisotropy in the plane.

### (Feature 4)

The medium according to feature 1, wherein

the second magnetic layer includes a crystal grain, and

magneto-crystalline anisotropy of the crystal grain includes a component aligned with the plane.

### (Feature 5)

The medium according to feature 1, wherein

the second magnetic layer includes a plurality of crystal grains,

each of the crystal grains has a first length and a second length, the first length being along a second direction perpendicular to the first direction, the second length being along a third direction perpendicular to the first direction and perpendicular to the second direction, and

an average of the first lengths of the crystal grains is different from an average of the second lengths.

### (Feature 6)

The medium according to feature 1 or 2, wherein the magnetic anisotropy includes shape magnetic anisotropy in the plane.

### (Feature 7)

The medium according to feature 1 or 2, wherein

the second magnetic layers is provided in a plurality, and

a first axis length along a second direction of one of the second magnetic layers is different from a second axis length along a third direction of the one of the second magnetic layers, the second direction being perpendicular to the first direction, the third direction being perpendicular to the first direction and perpendicular to the second direction.

### (Feature 8)

The medium according to feature 7, further comprising a substrate,

the first magnetic layer and the second magnetic layer being provided on the substrate,

a configuration of the substrate in the plane being a circle,

the second direction being aligned with a circumferential direction of the circle,

the third direction being aligned with a radial direction passing through a center of the circle,

the first axis length being shorter than the second axis length.

### (Feature 9)

The medium according to feature 1 or 2, wherein the magnetic anisotropy includes induced magnetic anisotropy in the plane.

### (Feature 10)

The medium according to one of features 1 to 9, wherein at least a portion of a ferromagnetic resonance frequency band of the first magnetic layer overlaps at least a portion of a ferromagnetic resonance frequency band of the second magnetic layer when a recording magnetic field is applied.

### (Feature 11)

The medium according to one of features 1 to 10, wherein a magnetization motion of the first magnetic layer and a magnetization motion of the second magnetic layer are coupled by at least one of an antiferromagnetic interaction or a dipole interaction.

### (Feature 12)

The medium according to one of features 1 to 10, wherein a magnetic volume of the first magnetic layer is equal to a magnetic volume of the second magnetic layer.

### (Feature 13)

The medium according to one of features 1 to 11, wherein a product of a saturation magnetization of the first magnetic layer and a thickness along the first direction of the first magnetic layer is not less than 0.8 times and not more than 1.2 times a product of a saturation magnetization of the second magnetic layer and a thickness along the first direction of the second magnetic layer.

### (Feature 14)

The medium according to one of features 1 to 13, further comprising:

a third magnetic layer overlapping the first magnetic layer and the second magnetic layer in the first direction;

a fourth magnetic layer overlapping the first magnetic layer and the second magnetic layer in the first direction; and

an intermediate layer provided between a set including the first magnetic layer and the second magnetic layer and a set including the third magnetic layer and the fourth magnetic layer, the intermediate layer being nonmagnetic,

an easy magnetization axis of the third magnetic layer being aligned with the first direction,

the fourth magnetic layer having the magnetic anisotropy in the plane perpendicular to the first direction,

a fourth magnetization of the fourth magnetic layer being reverse orientation of a third magnetization of the third magnetic layer.

### (Feature 15)

The medium according to feature 14, wherein a ferromagnetic resonance frequency of the third magnetic layer is different from a ferromagnetic resonance frequency of the first magnetic layer.

### (Feature 16)

A magnetic recording medium, comprising:

a first magnetic layer; and

a second magnetic layer,

an easy magnetization axis of the first magnetic layer being aligned with a first direction, the first direction being from the first magnetic layer toward the second magnetic layer,

a second magnetization of the second magnetic layer being reverse orientation of a first magnetization of the first magnetic layer,

the second magnetic layer including a plurality of crystal grains,

each of the crystal grains having a first length and a second length, the first length being along a second direction perpendicular to the first direction, the second length being along a third direction perpendicular to the first direction and perpendicular to the second direction, and

the first length of each of the crystal grains being different from the second length.

### (Feature 17)

The medium according to feature 16, wherein at least a portion of a ferromagnetic resonance frequency band of the first magnetic layer overlaps at least a portion of a ferromagnetic resonance frequency band of the second magnetic layer when a recording magnetic field is applied.

### (Feature 18)

The medium according to feature 16 or 17, wherein magnetization motion of the first magnetic layer and magnetization motion of the second magnetic layer are coupled by at least one of an antiferromagnetic interaction or a dipole interaction.

### (Feature 19)

The medium according to one of features 16 to 18, wherein a magnetic volume of the first magnetic layer is equal to a magnetic volume of the second magnetic layer.

### (Feature 20)

The medium according to one of features 16 to 19, wherein a product of a saturation magnetization of the first magnetic layer and a thickness along the first direction of the first magnetic layer is not less than 0.8 times and not more than 1.2 times a product of a saturation magnetization of the second magnetic layer and a thickness along the first direction of the second magnetic layer.

### (Feature 21)

The medium according to one of features 16 to 20, further comprising:

a third magnetic layer overlapping the first magnetic layer and the second magnetic layer in the first direction;

a fourth magnetic layer overlapping the first magnetic layer and the second magnetic layer in the first direction; and

an intermediate layer provided between a set including the first magnetic layer and the second magnetic layer and a set including the third magnetic layer and the fourth magnetic layer, the intermediate layer being nonmagnetic,

an easy magnetization axis of the third magnetic layer being aligned with the first direction,

a fourth magnetization of the fourth magnetic layer being reverse orientation of a third magnetization of the third magnetic layer,

the fourth magnetic layer including a plurality of crystal grains,

each of the crystal grains of the fourth magnetic layer having a fourth length and a fifth length, the fourth length being along a fourth direction perpendicular to the first direction, the fifth length being along a fifth direction perpendicular to the first direction and perpendicular to the fourth direction, and

the fourth length of each of the crystal grains of the fourth magnetic layer being different from the fifth length.

### (Feature 22)

The medium according to feature 21, wherein a ferromagnetic resonance frequency of the third magnetic layer is different from a ferromagnetic resonance frequency of the first magnetic layer.

### (Feature 23)

A magnetic recording medium, comprising:

a first magnetic layer; and

a second magnetic layer,

an easy magnetization axis of the first magnetic layer being aligned with a first direction, the first direction being from the first magnetic layer toward the second magnetic layer,

a second magnetization of the second magnetic layer being reverse orientation of a first magnetization of the first magnetic layer,

the second magnetic layer including a plurality of crystal grains,

each of the crystal grains having a first length and a second length, the first length being along a second direction perpendicular to the first direction, the second length being along a third direction perpendicular to the first direction and perpendicular to the second direction, and

an average of the first lengths of the crystal grains being different from an average of the second lengths.

### (Feature 24)

The medium according to feature 23, wherein at least a portion of a ferromagnetic resonance frequency band of the first magnetic layer overlaps at least a portion of a ferromagnetic resonance frequency band of the second magnetic layer when a recording magnetic field is applied.

### (Feature 25)

The medium according to feature 23 or 24, wherein magnetization motion of the first magnetic layer and magnetization motion of the second magnetic layer are coupled by at least one of an antiferromagnetic interaction or a dipole interaction.

### (Feature 26)

The medium according to one of features 23 to 25, wherein a magnetic volume of the first magnetic layer is equal to a magnetic volume of the second magnetic layer.

### (Feature 27)

The medium according to one of features 23 to 26, wherein a product of a saturation magnetization of the first magnetic layer and a thickness along the first direction of the first magnetic layer is not less than 0.8 times and not more than 1.2 times a product of a saturation magnetization of the second magnetic layer and a thickness along the first direction of the second magnetic layer.

### (Feature 28)

The medium according to one of features 23 to 27, further comprising:

a third magnetic layer overlapping the first magnetic layer and the second magnetic layer in the first direction;

a fourth magnetic layer overlapping the first magnetic layer and the second magnetic layer in the first direction; and

an intermediate layer provided between a set including the first magnetic layer and the second magnetic layer and a set including the third magnetic layer and the fourth magnetic layer, the intermediate layer being nonmagnetic,

an easy magnetization axis of the third magnetic layer being aligned with the first direction,

a fourth magnetization of the fourth magnetic layer being reverse orientation of a third magnetization of the third magnetic layer,

the fourth magnetic layer including a plurality of crystal grains,

each of the crystal grains having a third length and a fourth length, the third length being along a fourth direction perpendicular to the first direction, the fourth length being along a fifth direction perpendicular to the first direction and perpendicular to the fourth direction, and

an average of the third lengths of the crystal grains being different from an average of the fourth lengths.

### (Feature 29)

The medium according to feature 28, wherein a ferromagnetic resonance frequency of the third magnetic layer is different from a ferromagnetic resonance frequency of the first magnetic layer.

### (Feature 30)

A magnetic recording medium, comprising:

a first magnetic layer; and

a second magnetic layer,

an easy magnetization axis of the first magnetic layer being aligned with a first direction, the first direction being from the first magnetic layer toward the second magnetic layer,

a second magnetization of the second magnetic layer being reverse orientation of a first magnetization of the first magnetic layer,

the second magnetic layer being provided in a plurality, and

a first axis length along a second direction of one of the second magnetic layers is different from a second axis length along a third direction of the one of the second magnetic layers, the second direction being perpendicular to the first direction, the third direction being perpendicular to the first direction and perpendicular to the second direction.

### (Feature 31)

The medium according to feature 30, wherein at least a portion of a ferromagnetic resonance frequency band of the first magnetic layer overlaps at least a portion of a ferromagnetic resonance frequency band of the second magnetic layer when a recording magnetic field is applied.

### (Feature 32)

The medium according to feature 30 or 31, wherein magnetization motion of the first magnetic layer and magnetization motion of the second magnetic layer are coupled by at least one of an antiferromagnetic interaction or a dipole interaction.

### (Feature 33)

The medium according to one of features 30 to 32, wherein a magnetic volume of the first magnetic layer is equal to a magnetic volume of the second magnetic layer.

### (Feature 34)

The medium according to one of features 30 to 33, wherein a product of a saturation magnetization of the first magnetic layer and a thickness along the first direction of the first magnetic layer is not less than 0.8 times and not more than 1.2 times a product of a saturation magnetization of the second magnetic layer and a thickness along the first direction of the second magnetic layer.

### (Feature 35)

The medium according to one of features 30 to 34, further comprising:

a third magnetic layer overlapping the first magnetic layer and the second magnetic layer in the first direction;

a fourth magnetic layer overlapping the first magnetic layer and the second magnetic layer in the first direction; and

an intermediate layer provided between a set including the first magnetic layer and the second magnetic layer and a set including the third magnetic layer and the fourth magnetic layer, the intermediate layer being nonmagnetic,

an easy magnetization axis of the third magnetic layer being aligned with the first direction,

a fourth magnetization of the fourth magnetic layer being reverse orientation of a third magnetization of the third magnetic layer,

the fourth magnetic layer is provided in a plurality, and

a third axis length along a fourth direction of one of the fourth magnetic layers is different from a fourth axis length along a fifth direction of the one of the fourth magnetic layers, the fourth direction being perpendicular to the first direction, the fifth direction being perpendicular to the first direction and perpendicular to the fourth direction.

### (Feature 36)

The medium according to feature 35, wherein a ferromagnetic resonance frequency of the third magnetic layer is different from a ferromagnetic resonance frequency of the first magnetic layer.

### (Feature 37)

A magnetic recording and reproducing device, comprising:

the magnetic recording medium according to one of features 1 to 36; and

a magnetic head applying a magnetic field to the magnetic recording medium.

### (Feature 38)

The device according to feature 37, wherein the magnetic head applies a high frequency magnetic field and a recording magnetic field to the magnetic recording medium.

According to the embodiments, a magnetic recording medium and a magnetic recording and reproducing device in which the recording density can be increased.

In this specification, “perpendicular” and “parallel” include not only strictly perpendicular and strictly parallel but also, for example, the fluctuation due to manufacturing processes, etc.; and it is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic recording media such as magnetic layers, nonmagnetic layers, and intermediate layers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic recording media and magnetic recording and reproducing devices practicable by an appropriate design modification by one skilled in the art based on the magnetic recording media and magnetic recording and reproducing devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic recording medium, comprising:
a first magnetic layer; and
a second magnetic layer,
an easy magnetization axis of the first magnetic layer being aligned with a first direction, the first direction being from the first magnetic layer toward the second magnetic layer,
the second magnetic layer having magnetic anisotropy in a plane perpendicular to the first direction,
a second magnetization of the second magnetic layer being reverse orientation of a first magnetization of the first magnetic layer.

2. The medium according to claim 1, further comprising a nonmagnetic layer provided between the first magnetic layer and the second magnetic layer.

3. The medium according to claim 1, wherein the magnetic anisotropy includes magneto-crystalline anisotropy in the plane.

4. The medium according to claim 1, wherein
the second magnetic layer includes a crystal grain, and
magneto-crystalline anisotropy of the crystal grain includes a component aligned with the plane.

5. The medium according to claim 1, wherein
the second magnetic layer includes a plurality of crystal grains,
each of the crystal grains has a first length and a second length, the first length being along a second direction perpendicular to the first direction, the second length being along a third direction perpendicular to the first direction and perpendicular to the second direction, and
an average of the first lengths of the crystal grains is different from an average of the second lengths.

6. The medium according to claim 1, wherein the magnetic anisotropy includes shape magnetic anisotropy in the plane.

7. The medium according to claim 1, wherein
the second magnetic layer is provided in a plurality, and
a first axis length along a second direction of one of the second magnetic layers is different from a second axis length along a third direction of the one of the second magnetic layers, the second direction being perpendicular to the first direction, the third direction being perpendicular to the first direction and perpendicular to the second direction.

8. The medium according to claim 7, further comprising a substrate,
the first magnetic layer and the second magnetic layer being provided on the substrate,
a configuration of the substrate in the plane being a circle,
the second direction being aligned with a circumferential direction of the circle,
the third direction being aligned with a radial direction passing through a center of the circle,
the first axis length being shorter than the second axis length.

9. The medium according to claim 1, wherein the magnetic anisotropy includes induced magnetic anisotropy in the plane.

10. The medium according to claim 1, wherein at least a portion of a ferromagnetic resonance frequency band of the first magnetic layer overlaps at least a portion of a ferromagnetic resonance frequency band of the second magnetic layer when a recording magnetic field is applied.

11. The medium according to claim 1, wherein a magnetization motion of the first magnetic layer and a magnetization motion of the second magnetic layer are coupled by at least one of an antiferromagnetic interaction or a dipole interaction.

12. The medium according to claim 1, wherein a magnetic volume of the first magnetic layer is equal to a magnetic volume of the second magnetic layer.

13. The medium according to claim 1, wherein a product of a saturation magnetization of the first magnetic layer and a thickness along the first direction of the first magnetic layer is not less than 0.8 times and not more than 1.2 times a product of a saturation magnetization of the second magnetic layer and a thickness along the first direction of the second magnetic layer.

14. The medium according to claim 1, further comprising:
a third magnetic layer overlapping the first magnetic layer and the second magnetic layer in the first direction;
a fourth magnetic layer overlapping the first magnetic layer and the second magnetic layer in the first direction; and
an intermediate layer provided between a set including the first magnetic layer and the second magnetic layer and a set including the third magnetic layer and the fourth magnetic layer, the intermediate layer being nonmagnetic,
an easy magnetization axis of the third magnetic layer being aligned with the first direction,
the fourth magnetic layer having the magnetic anisotropy in the plane perpendicular to the first direction,
a fourth magnetization of the fourth magnetic layer being reverse orientation of a third magnetization of the third magnetic layer.

15. The medium according to claim 14, wherein a ferromagnetic resonance frequency of the third magnetic layer is different from a ferromagnetic resonance frequency of the first magnetic layer.

16. A magnetic recording and reproducing device, comprising:
a magnetic recording medium; and
a magnetic head applying a magnetic field to the magnetic recording medium,
the magnetic recording medium including:
a first magnetic layer; and
a second magnetic layer,
an easy magnetization axis of the first magnetic layer being aligned with a first direction, the first direction being from the first magnetic layer toward the second magnetic layer,
the second magnetic layer having magnetic anisotropy in a plane perpendicular to the first direction,
a second magnetization of the second magnetic layer being reverse orientation of a first magnetization of the first magnetic layer.

17. The device according to claim 16, wherein the magnetic head applies a high frequency magnetic field and a recording magnetic field to the magnetic recording medium.
